(19) United States
(12) Patent Application Publication
(10) Pub. No.: US 2011/0130161 A1
(43) Pub. Date: Jun. 2, 2011

(54) TERMINAL AND BASE STATION, AND FREQUENCY SENSING METHOD THEREOF

(75) Inventors: Sang In CHO, Daejeon (KR); Kyu-Min KANG, Daejeon (KR); Heon Jin HONG, Daejeon (KR)

(73) Assignee: ELECTRONICS AND TELECOMMUNICATIONS RESEARCH INSTITUTE, Daejeon (KR)

(21) Appl. No.: 12/873,404

(22) Filed: Sep. 1, 2010

(30) Foreign Application Priority Data
Nov. 30, 2009 (KR) 10-2009-0116689

(51) Int. Cl. H04B 1/10; H04B 1/16; H04B 7/00

(52) U.S. Cl. 455/507; 455/334; 455/307

(57) ABSTRACT

Provided are a terminal and a base station, and a frequency sensing method thereof. The terminal or the base station may filter a frequency band needing frequency sensing in the entire frequency band where the terminal or the base station may receive an input signal. It is possible to enhance a detection performance and rate of signals by applying frequency sensing to the filtered frequency band.

### CROSS-REFERENCE TO RELATED APPLICATION

This application claims the benefit of Korean Patent Application No. 10-2009-0116689, filed on Nov. 30, 2009, in the Korean Intellectual Property Office, the disclosure of which is incorporated herein by reference.

### BACKGROUND

1. Field of the Invention

The present invention relates a terminal and a base station, and a frequency sensing method thereof, and more particularly, to a terminal and a base station that may filter a frequency band needing a frequency sensing and then perform the frequency sensing, and a frequency sensing method thereof.

2. Description of the Related Art

In the case of a current wireless communication environment, different wireless communication systems exist in the same frequency band. Each of the wireless communication systems may use a different occupancy bandwidth. However, each of the wireless communication systems may be unaware of an environment of a frequency band to be used and thus may cause interference in another wireless communication system. Also, a terminal desired to be used may support various types of wireless communication schemes and employ a most appropriate wireless communication scheme. Accordingly, a required frequency band or bandwidth may vary upon circumstances.

A frequency sensing may be applied to prevent a plurality of wireless communication systems from operating as interference sources against each other, and to effectively sense an available frequency band according to a wireless communication scheme to be used by a terminal. However, since a conventional frequency sensing is performed with respect to the entire frequency band, an unnecessary frequency band may also be sensed. Accordingly, a signal detection performance may be deteriorated and the frequency sensing may consume a large amount of time.

### SUMMARY

An aspect of the present invention provides a terminal and a base station that may enhance a signal detection performance by selecting, from the entire frequency band, a band needing frequency sensing and thereby performing frequency sensing, and a frequency sensing method thereof.

According to an aspect of the present invention, there is provided a terminal for frequency sensing in a wireless communication system, including: a transceiver to receive an input signal; and a frequency sensing unit to apply a frequency sensing to a frequency band to be used by the terminal in the entire frequency band where the terminal is enabled to the input signal.

The frequency sensing unit may include: a controller to set a pass band based on the frequency band to be used by the terminal; a band pass filter to filter the frequency band to be used by the terminal, based on the set pass band; and a signal detector to detect an interference signal in the filtered frequency band to be used by the terminal.

The controller may variably set the pass band by further considering a frequency band where an external wireless communication system may exist. The band pass filter may correspond to a variable band pass filter.

The controller may set the pass band of the band pass filter to include the frequency band to be used by the terminal and the frequency band where the external wireless communication system may exit.

The frequency sensing unit may further include: a down sampling unit to down sample a signal of the filtered frequency band to be used by the terminal, and a sampling rate of the down sampling unit is determined based on the pass band of the band pass filter.

According to another aspect of the present invention, there is provided a frequency sensing method of a terminal, including: receiving an input signal; and performing frequency sensing with respect to a frequency band to be used by the terminal in the entire frequency band where the terminal is enabled to the input signal.

The performing may include: setting a pass band of a band pass filter based on the frequency band to be used by the terminal; filtering the frequency band to be used by the terminal based on the set pass band; and detecting an interference signal in the filtered frequency band to be used by the terminal.

The setting may include variably setting the pass band by further considering a frequency band where an external wireless communication system may exist.

The setting may include setting the pass band to include the frequency band to be used by the terminal and the frequency band where the external wireless communication system may exit.

The method may further include down sampling a signal of the filtered frequency band to be used by the terminal. A sampling rate of the down sampling unit may be determined based on the pass band of the band pass filter.

According to still another aspect of the present invention, there is provided a base station for frequency sensing in a wireless communication system, including: a transceiver to communicate with a terminal; and a frequency sensing unit to apply a frequency sensing to a frequency band to be used by the terminal in the entire frequency band where an input signal is received from the terminal.

The frequency sensing unit may include: a controller to set a pass band based on the frequency band to be used by the terminal; a band pass filter to filter the frequency band to be used by the terminal, based on the set pass band; and a signal detector to detect an interference signal in the filtered frequency band to be used by the terminal.

The controller may variably set the pass band by further considering a frequency band where an external wireless communication system may exist. The band pass filter may correspond to a variable band pass filter.

The controller may set the pass band to include the frequency band to be used by the terminal and the frequency band where the external wireless communication system may exit.

The frequency sensing unit may further include: a down sampling unit to down sample a signal of the filtered frequency band to be used by the terminal, and a sampling rate of the down sampling unit is determined based on the pass band of the band pass filter.

According to yet another aspect of the present invention, there is provided a frequency sensing method of a base station, including: communicating with a terminal; and applying a frequency sensing to a frequency band to be used by the terminal in the entire frequency band where an input signal is received from the terminal.

The applying of the frequency sensing may include: setting a pass band of a band pass filter based on the frequency band to be used by the terminal; filtering the frequency band to be used by the terminal, based on the set pass band; and detecting an interference signal in the filtered frequency band to be used by the terminal.

The setting may include variably setting the pass band by further considering a frequency band where an external wireless communication system may exist.

The setting may include setting the pass band to include the frequency band to be used by the terminal and the frequency band where the external wireless communication system may exit.

The method may further include down sampling a signal of the filtered frequency band to be used by the terminal. A sampling rate of the down sampling unit may be determined based on the pass band of the band pass filter.

### EFFECT

According to embodiments of the present invention, when performing frequency sensing, a required frequency band may be filtered using a variable band pass filter. Accordingly, it is possible to enhance a signal detection performance, and to decrease an amount of time used for frequency sensing.

Also, according to embodiments of the present invention, it is possible to filter various frequency bands using a variable band pass filter.

Also, according to embodiments of the present invention, it is possible to inspect only a required frequency band interval at a high resolution by applying down sampling.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a base station and terminals belonging to a single cell among a plurality of cells according to an embodiment of the present invention;

FIG. 2 is a block diagram illustrating a terminal for frequency sensing according to an embodiment of the present invention;

FIG. 3 is a block diagram illustrating a configuration of a frequency sensing unit of FIG. 2;

FIGS. 4 and 5 are diagrams to describe the entire frequency band of an input signal and a frequency band to be used by a first terminal when a wireless communication system operates according to an embodiment of the present invention;

FIG. 6 is a diagram to describe a frequency band of a down-sampled output signal and a band for frequency sensing according to an embodiment of the present invention;

FIG. 7 is a block diagram illustrating a base station for frequency sensing according to an embodiment of the present invention;

FIG. 8 is a flowchart illustrating a frequency sensing method of a terminal according to an embodiment of the present invention; and

FIG. 9 is a flowchart illustrating a frequency sensing method of a base station according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

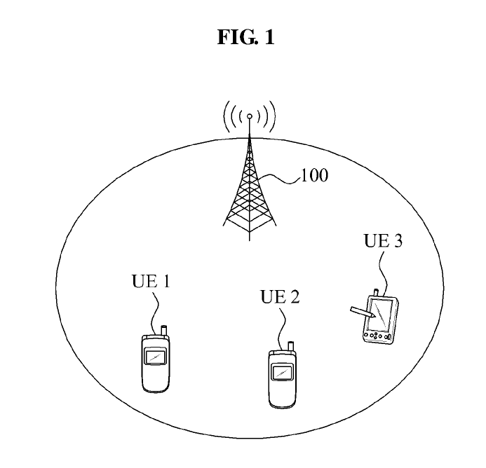

FIG. 1 is a diagram illustrating a base station 100 and terminals UE1, UE2, and UE3 belonging to a single cell among a plurality of cells according to an embodiment of the present invention.

Referring to FIG. 1, the base station 100 and the terminals UE1, UE2, and UE3 are included in the single cell. Since the base station 100 and the terminals UE1, UE2, and UE3 coexist in the same frequency band, various types of wireless communication systems may exist. In this instance, when a particular wireless communication system operates, the particular wireless communication system may be unaware of an environment of a frequency band to be used and thus may cause interference in another wireless communication system. According to an embodiment of the present invention, a wireless communication system may perform frequency sensing to not act as an interference source.

The frequency sensing may correspond to a process of inspecting in advance a frequency band to be used and detecting whether the frequency band is being used in another wireless communication system, before the base station 100 and a single terminal, for example, the terminal UE1 operate as the wireless communication system.

When a signal of the other wireless communication system is detected in the frequency band, the wireless communication system may use another frequency band. Even in a case where the signal of the other wireless communication system is not detected and thus the wireless communication system may use the frequency band, when still another wireless communication system to be protected desires to use the frequency band, the wireless communication system may need to yield the frequency band. Accordingly, frequency sensing may be periodically or continuously performed.

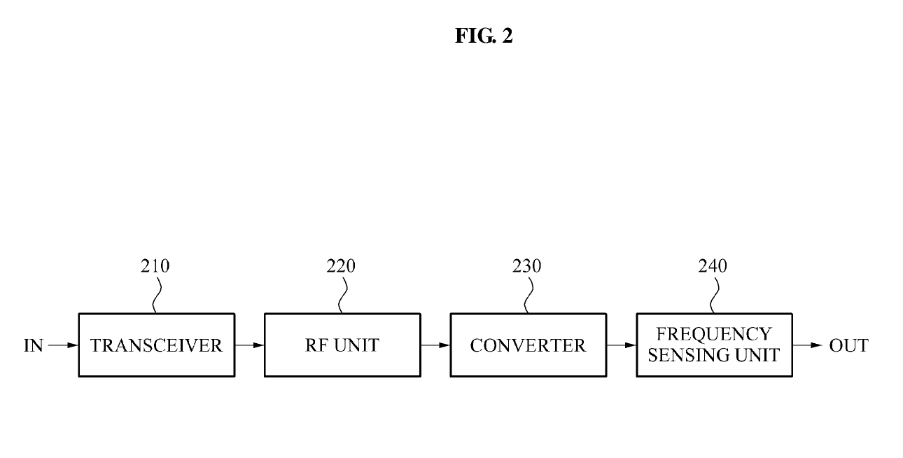

FIG. 2 is a block diagram illustrating a terminal for frequency sensing according to an embodiment of the present invention.

The terminal may be, for example, one of the terminals UE1, UE2, and UE3 of FIG. 1, or may be a portable user equipment such as a mobile phone. Hereinafter, description will be made using a first terminal.

The first terminal may include a transceiver 210, a radio frequency (RF) unit 220, a converter 230, and a frequency sensing unit 240.

The transceiver 210 corresponds to an interface module configured to communicate with a base station or a terminal, and may receive an input signal from an external system via a receive interface such as an antenna. The external system may be, for example, a communication system formed between the base station and other terminals.

The RF unit 220 may determine the entire frequency band f_{BW} of the input signal by converting the received input signal to a baseband signal. The entire frequency band f_{BW} of the input signal may be a frequency band where the first terminal may perform communication, that is, may receive the input signal.

The converter 230 may convert, to a digital signal, the baseband signal that is an analog signal. Through this, the baseband signal may have the entire frequency band f_{BW}.

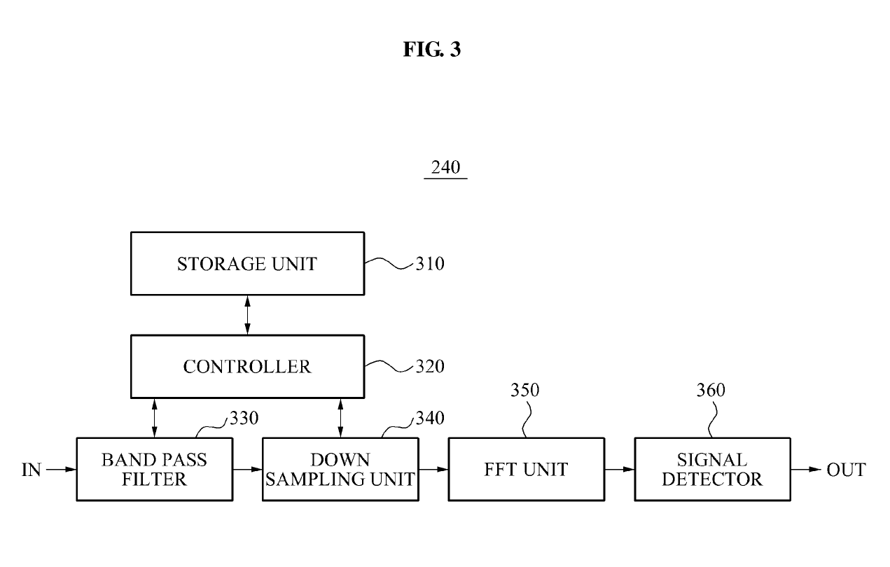

The frequency sensing unit 240 may apply frequency sensing with respect to a frequency band f_{D} to be used by the first terminal in the entire frequency band f_{BW}, instead of the entire frequency band f_{BW} converted to the digital signal. The frequency band f_{D} to be used by the first terminal may be a band for frequency sensing in a signal detector 360 of FIG. 3.

FIG. 3 is a block diagram illustrating a configuration of the frequency sensing unit 240 of FIG. 2.

Referring to FIG. 3, the frequency sensing unit 240 may include a storage unit 310, a controller 320, a band pass filter 330, a down sampling unit 340, a fast Fourier transform (FFT) unit 350, and the signal detector 360.

According to an embodiment of the present invention, when a wireless communication system between the base station and the first terminal operates, a frequency band where another wireless communication system causing interference or acting as an interference source may exist may be limited. Accordingly, the frequency sensing unit 240 may sense only the frequency band f_{D} to be used by the first terminal or a band including the frequency band f_{D}, instead of sensing the entire frequency band f_{BW} of the input signal.

For this, the storage unit 310 may store the entire frequency band f_{BW} where the first terminal may receive the input signal, the frequency band f_{D} to be used by the first terminal, and an external frequency band f_{V}. The frequency band f_{D} may be pre-stored in the first terminal, and the external frequency band f_{V} may be known through a communication with an external wireless communication system.

The controller 320 may set a pass band of the band pass filter 330 based on the frequency band f_{D} stored in the storage unit 310. Also, the controller 320 may set the pass band by further considering the external frequency band f_{V} in addition to the frequency band f_{D} to be used by the first terminal.

The controller 320 may set the pass band of the band pass filter 330 to include the frequency band f_{D} to be used by the first terminal and the external frequency band f_{V}. For example, when the entire frequency band f_{BW} is 0 to 500 MHz, the frequency band f_{D} to be used by the first terminal is 100 MHz to 150 MHz, and the external frequency band f_{V} is 160 MHz to 170 MHz, the pass band may be set to include a minimum of 100 MHz to 150 MHz and 160 MHz to 170 MHz. Since the frequency band f_{D} to be used by the first terminal and the external frequency band f_{V} are variable depending on circumstances, the pass band may also vary.

Also, the controller 320 may set an order of down sampling based on the set pass band. When the controller 320 sets the pass band to the entire frequency band f_{BW}/n, the order of down sampling may be set to n. Here, n denotes a constant. Accordingly, a sampling rate of the down sampling unit 340 may be determined to be in proportion to a ratio of the pass band to the entire frequency band f_{BW} of the input signal

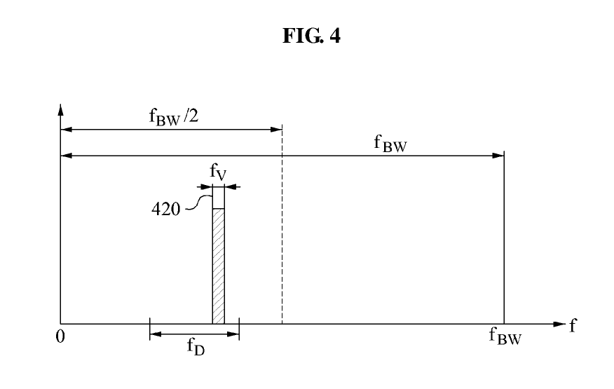

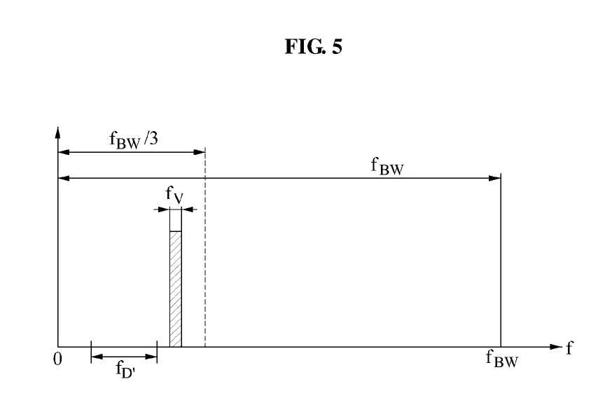

FIGS. 4 and 5 are diagrams to describe the entire frequency band of an input signal and a frequency band to be used by a first terminal when a wireless communication system operates according to an embodiment of the present invention.

Referring to FIG. 4, f_{BW} denotes the entire frequency band of the input signal and f_{D} denotes the frequency band to be used by the first terminal. The frequency band f_{D} to be used by the first terminal corresponds to a band needing frequency sensing to operate the wireless communication system, and thus may correspond to a frequency band where another wireless communication system may exist or where the wireless communication system operates. f_{V} denotes a possible frequency band of a signal 420 of the other wireless communication system when the signal 420 exists in the frequency band f_{D} needing the frequency sensing.

In FIG. 4, the frequency band f_{D} to be used by the first terminal exists within 0 to f_{BW}/2 of the entire frequency band f_{BW}. Accordingly, the controller 320 may set the pass band to 0 to f_{BW}/2. Also, as shown in FIG. 5, when a frequency band f_{D′} to be used by the first terminal exists within an interval corresponding to ⅓ of the entire frequency band f_{BW}, the controller 320 may set the pass band to 0 to f_{BW}/3. In this instance, the controller 320 may set an order of down sampling to 3.

The pass band filter 330 may filter a frequency band of 0 to f_{BW}/2 including the frequency band f_{D} to be used by the first terminal in the entire frequency band f_{BW} and the external frequency band f_{V}. Since the band pass filter 330 may filter the frequency band 0 to f_{BW}/2 corresponding to the set pass band, the filtered frequency band 0 to f_{BW}/2 may include the interval needing the frequency sensing, for example, the frequency band f_{D}. Since the pass band used by the band pass filter 330 is variable by the controller 320, the band pass filter 330 may correspond to a variable band pass filter.

The down sampling unit 340 may down sample a signal of the filtered frequency band f_{D} to be used by the first terminal. Also, the down sampling unit 340 may apply down sampling to a signal of the frequency band filtered by the band pass filter 330.

An order of down sampling used by the down sampling unit 340 may be determined based on the pass band set by the controller 320. Due to filtering of the band pass filter 330, a frequency band where a signal exists may be narrowed. Accordingly, the down sampling unit 340 may decrease a number of signals to be sampled and thereby omit an unnecessary calculation and enhance a frequency resolution of FFT. For example, when the pass band is f_{BW}/2 corresponding to ½ of the entire frequency band f_{BW}, a frequency bandwidth of the signal may be reduced to a half due to filtering. In this case, a frequency resolution by the down sampling unit 340 is f_{BW}/2 and thus is two folds compared to f_{BW} and down sampling may be performed at a two-fold fast rate.

The FFT unit 350 may divide the filtered frequency band into a plurality of sub-channels according to an FFT algorithm. The FFT unit 350 may divide, into the plurality of sub-channels, the frequency band f_{D} to be used by the first terminal in the filtered frequency band. When the FFT unit 350 performs N-point FFT for frequency sensing, a resolution of the sub-channels may be f_{BW}/2N.

An output signal obtained by performing FFT of the input signal may be represented by,

$$X ( k ) = {\sum }_{n = 0}^{N - 1} x ( n ) {e}_{N}^{- j2π nk} , k = 0 , 1 , L , N - 1 \qquad [ Equation 1 ]$$

In Equation 1, x(n) denotes the input signal, X(k) denotes the output signal of the FFT unit 350, and N denotes a N-point FFT result of the FFT unit 350 that is indicated as a spectrum. This is to enable the filtered frequency band to have a high resolution. For example, when the input signal has a frequency band of 0 to 100 MHz and the FFT unit 350 applies 8-point FFT, a signal output from the FFT unit 350 may have a resolution of 100/8. Accordingly, when performing FFT of a signal of the frequency band filtered by the band pass filter 330, the signal may have a resolution greater than 100/8.

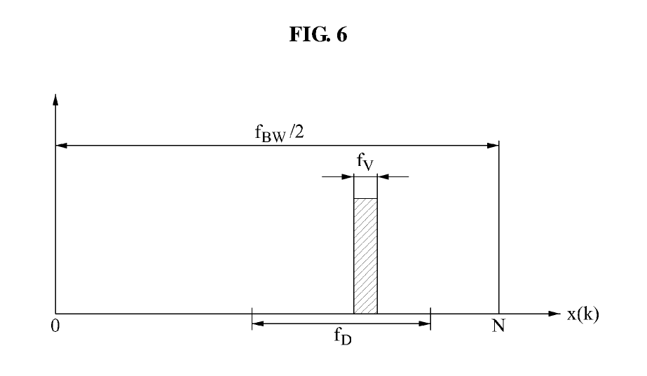

FIG. 6 is a diagram to describe a frequency band of a down-sampled output signal and a band for frequency sensing according to an embodiment of the present invention.

Referring to FIG. 6, the pass band of the band pass filter 330 may be set to 0 to f_{BW}/2 based on the frequency band f_{D} and the external frequency band f_{V} and only a half of the entire frequency band f_{BW} may be filtered. Accordingly, when an order of down sampling is set to 2, a signal output from the down sampling unit 340 may have a frequency band of f_{BW}/2 and f_{D} may correspond to a band needing frequency sensing.

Referring to FIGS. 4 and 6, compared to the signal to be down sampled by the down sampling unit 340 in FIG. 4, the signal to be down sampled by the down sampling unit 340 is reduced to 50% in FIG. 6. Accordingly, the FFT unit 350 may perform FFT with respect to a half of the filtered frequency band and thus may quickly perform FFT, which may result in reducing an amount of time used for frequency sensing.

The signal detector 360 may perform signal processing for each of sub-channels or sub-carriers divided by the FFT unit 350, and thereby detect a signal or an interference signal of another wireless communication system.

According to an embodiment of the present invention, when performing frequency sensing, the first terminal may selectively perform frequency sensing, instead of performing frequency sensing with respect to the entire frequency band available by the first terminal. Accordingly, it is possible to decrease an amount of time used for frequency sensing, and to effectively detect a signal in a frequency band having a high resolution.

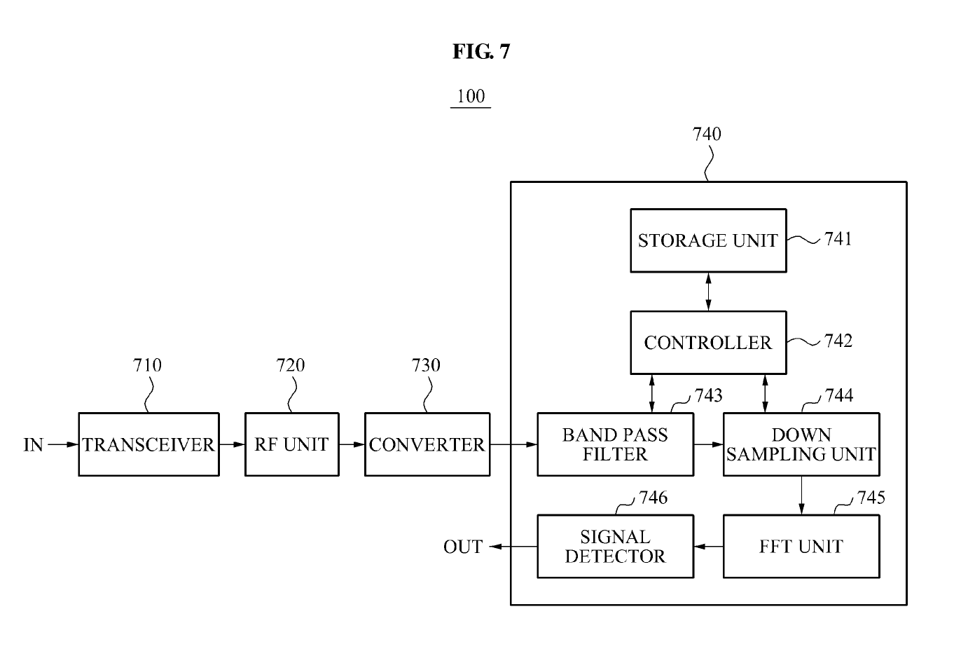

FIG. 7 is a block diagram illustrating a base station 100 for frequency sensing according to an embodiment of the present invention.

Referring to FIG. 7, the base station 100 may include a transceiver 710, an RF unit 720, a converter 730, and a frequency sensing unit 740. The transceiver 710, the RF unit 720, the converter 730, and the frequency sensing unit 740 of FIG. 7 may be configured to be similar to the transceiver 210, the RF unit 220, the converter 230, and the frequency sensing unit 240 of FIG. 4, and thus further detailed description related thereto will be omitted here.

In this instance, the transceiver 710 corresponds to an interference module configured to communicate with a neighboring base station or a terminal, and thus may receive an input signal from the terminal via a receive interface such as an antenna. The input signal may include a signal associated with request for allocation of a frequency band or a communication. Hereinafter, a first terminal may be used as the terminal transmitting the input signal.

The RF unit 720 may determine the entire frequency band f_{BW} usable by the first terminal among operational bands where a plurality of wireless communication systems coexists. For example, the RF unit 720 may determine the entire frequency band f_{BW} by converting the input signal received from the communicating first terminal to a baseband signal. The entire frequency band f_{BW} may be a frequency band where the base station 100 or the first terminal may perform communication. Specifically, the entire frequency band f_{BW} may be a frequency bandwidth where the input signal may be received from the first terminal or the first terminal may receive the input signal.

The converter 730 may convert, to a digital signal, the baseband signal that is an analog signal. Accordingly, the baseband signal may have the entire frequency band f_{BW}.

The frequency sensing unit 740 may apply frequency sensing with respect to a frequency band f_{D} to be used by the first terminal in the entire frequency band f_{BW}. The frequency sensing unit 740 may include a storage unit 741, a controller 742, a band pass filter 743, a down sampling unit 744, an FFT 745, and a signal detector 746.

The storage unit 741 may store the frequency band f_{D} to be used by the first terminal and an external frequency band f_{V} where an external system may exist. The external frequency band f_{V} may be known through communication with the external system.

The controller 742 may set a pass band of the band pass filter 743 based on the frequency band f_{D} to be used by the first terminal and the external frequency band f_{V}. Specifically, the controller 742 may set the pass band of the band pass filter 743 to include the frequency band f_{D} to be used by the first terminal and the external frequency band f_{V}. Since the frequency band f_{D} to be used by the first terminal and the external frequency band f_{V} are variable depending on circumstances, the pass band may also be variable.

The controller 742 may set an order of the down sampling unit 744 based on the set pass band. Accordingly, a sampling rate of the down sampling unit 744 may be determined based on a ratio of the pass band to the entire frequency band f_{BW} of the input signal

The band pass filter 743 may filter a frequency band corresponding to the pass band set by the controller 742. The filtered frequency band, for example, 0 to f_{BW}/n may include an interval needing frequency sensing, for example, the frequency band f_{D}. Since the pass band used by the band pass filter 743 is variable by the controller 742, the band pass filter 743 may correspond to a variable band pass filter.

The down sampling unit 744 may perform down sampling of a signal of the frequency band f_{D} to be used by the first terminal. Also, the down sampling unit 744 may perform down sampling of a signal of the frequency band filtered by the band pass filter 743.

An order of down sampling used by the down sampling unit 744 may be determined based on the pass band set by the controller 742.

The FFT 745 may divide the filtered frequency band into a plurality of sub-channels according to an FFT algorithm. Also, the FFT 745 may divide, into the plurality of sub-channels, the frequency band f_{D} to be used by the first terminal in the filtered frequency band.

The signal detector 746 may perform signal processing for each of sub-channels or sub-carriers divided by the FFT 745, and thereby detect a signal or an interference signal of another wireless communication system.

As described above, according to an embodiment of the present invention, when performing frequency sensing, the base station 100 may selectively perform frequency sensing, instead of performing frequency sensing with respect to the entire frequency band available by the first terminal. Accordingly, it is possible to decrease an amount of time used for frequency sensing, and to effectively detect a signal in a frequency band having a high resolution.

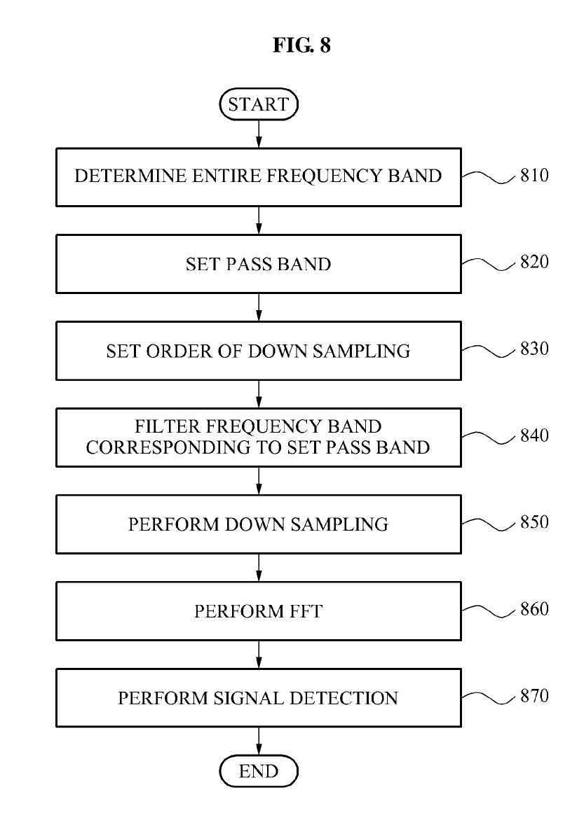

FIG. 8 is a flowchart illustrating a frequency sensing method of a terminal according to an embodiment of the present invention.

In operation 810, the RF unit 220 may determine the entire frequency band of an input signal.

In operation 820, the controller 820 may set a pass band of the band pass filter 330, based on a frequency band to be used by a first terminal and an external frequency band where an external wireless communication system may exist. The pass band set in operation 820 may include the frequency band to be used by the first terminal and the external frequency band.

In operation 830, the controller 320 may set an order of the down sampling unit 340 based on the set pass band.

In operation 840, the band pass filter 330 may filter a frequency band including the frequency band to be used by the first terminal in the entire frequency band and the external frequency band based on the set pass band.

In operation 850, the down sampling unit 340 may perform down sampling of a signal of the filtered frequency band. Also, the down sampling unit 340 may perform down sampling of a signal of the frequency band to be used by the first terminal in the filtered frequency band.

In operation 860, the FFT unit 350 may divide the filtered frequency band into a plurality of sub-channels according to an FFT algorithm. Also, the FFT unit 350 may divide, into the plurality of sub-channels, the frequency band to be used by the first terminal in the filtered frequency band.

In operation 870, the signal detector 360 may perform signal processing for each of sub-channels or sub-carriers divided in operation 860, and thereby detect a signal or an interference signal of another wireless communication system.

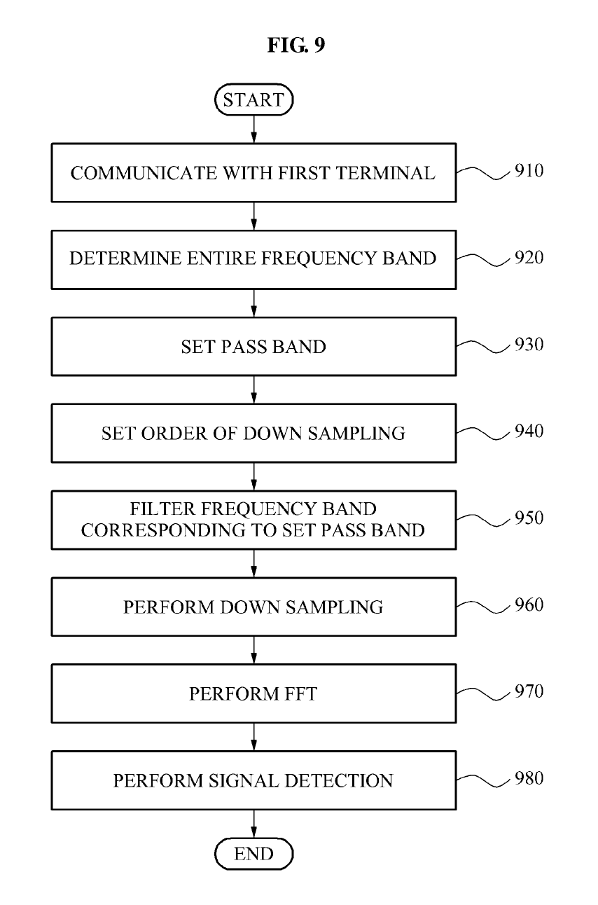

FIG. 9 is a flowchart illustrating a frequency sensing method of the base station 100 according to an embodiment of the present invention.

In operation 910, the transceiver 710 may communicate with a first terminal to receive an input signal.

In operation 920, the RF unit 720 may determine the entire frequency band by converting, to a baseband signal, the input signal received from the communicating first terminal.

In operation 930, the controller 742 may set a pass band including the frequency band to be used by the first terminal and an external frequency band.

In operation 940, the controller 742 may set an order of the down sampling unit 744 based on the set pass band.

In operation 950, the band pass filter 743 may filter a frequency band corresponding to the set pass band. The filtered frequency band may include an interval needing frequency sensing, for example, the frequency band to be used by the first terminal.

In operation 960, the down sampling unit 744 may perform down sampling of a signal of the filtered frequency band or the frequency band to be used by the first terminal in the filtered frequency band.

In operation 970, the FFT 745 may divide, into the plurality of sub-channels, the filtered frequency band or the frequency band to be used by the first terminal in the filtered frequency band according to an FFT algorithm.

In operation 980, the signal detector 746 may perform signal processing for each of sub-channels or sub-carriers divided by the FFT 745, and thereby detect a signal or an interference signal of another wireless communication system.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A terminal for frequency sensing in a wireless communication system, comprising:
a transceiver to receive an input signal; and
a frequency sensing unit to apply a frequency sensing to a frequency band to be used by the terminal in the entire frequency band where the terminal is enabled to the input signal.

2. The terminal of claim 1, wherein the frequency sensing unit comprises:
a controller to set a pass band based on the frequency band to be used by the terminal;
a band pass filter to filter the frequency band to be used by the terminal, based on the set pass band; and
a signal detector to detect an interference signal in the filtered frequency band to be used by the terminal.

3. The terminal of claim 2, wherein:
the controller variably sets the pass band by further considering a frequency band where an external wireless communication system exists, and
the band pass filter corresponds to a variable band pass filter.

4. The terminal of claim 3, wherein:
the controller sets the pass band of the band pass filter to include the frequency band to be used by the terminal and the frequency band where the external wireless communication system exits.

5. The terminal of claim 2, wherein the frequency sensing unit further comprises:
a down sampling unit to down sample a signal of the filtered frequency band to be used by the terminal, and
a sampling rate of the down sampling unit is determined based on the pass band of the band pass filter.

6. A frequency sensing method of a terminal, comprising:
receiving an input signal; and
performing frequency sensing with respect to a frequency band to be used by the terminal in the entire frequency band where the terminal is enabled to the input signal.

7. The method of claim 6, wherein the performing comprises:
setting a pass band of a band pass filter based on the frequency band to be used by the terminal;
filtering the frequency band to be used by the terminal based on the set pass band; and
detecting an interference signal in the filtered frequency band to be used by the terminal.

8. The method of claim 7, wherein the setting comprises variably setting the pass band by further considering a frequency band where an external wireless communication system exists.

9. The method of claim 8, wherein the setting comprises setting the pass band to include the frequency band to be used by the terminal and the frequency band where the external wireless communication system exits.

10. The method of claim 7, further comprising:
down sampling a signal of the filtered frequency band to be used by the terminal,
wherein a sampling rate of the down sampling unit is determined based on the pass band of the band pass filter.

11. A base station for frequency sensing in a wireless communication system, comprising:
a transceiver to communicate with a terminal; and
a frequency sensing unit to apply a frequency sensing to a frequency band to be used by the terminal in the entire frequency band where an input signal is received from the terminal.

12. The base station of claim 11, wherein the frequency sensing unit comprises:
a controller to set a pass band based on the frequency band to be used by the terminal;
a band pass filter to filter the frequency band to be used by the terminal, based on the set pass band; and
a signal detector to detect an interference signal in the filtered frequency band to be used by the terminal.

13. The base station of claim 12, wherein:
the controller variably sets the pass band by further considering a frequency band where an external wireless communication system exists, and
the band pass filter corresponds to a variable band pass filter.

14. The base station of claim 13, wherein:
the controller sets the pass band to include the frequency band to be used by the terminal and the frequency band where the external wireless communication system exits.

15. The base station of claim 12, wherein the frequency sensing unit further comprises:
a down sampling unit to down sample a signal of the filtered frequency band to be used by the terminal, and
a sampling rate of the down sampling unit is determined based on the pass band of the band pass filter.

16. A frequency sensing method of a base station, comprising:
communicating with a terminal; and
applying a frequency sensing to a frequency band to be used by the terminal in the entire frequency band where an input signal is received from the terminal.

17. The method of claim 16, wherein the applying of the frequency sensing comprises:
setting a pass band of a band pass filter based on the frequency band to be used by the terminal;
filtering the frequency band to be used by the terminal, based on the set pass band; and
detecting an interference signal in the filtered frequency band to be used by the terminal.

18. The method of claim 17, wherein the setting comprises variably setting the pass band by further considering a frequency band where an external wireless communication system exists.

19. The method of claim 18, wherein the setting comprises setting the pass band to include the frequency band to be used by the terminal and the frequency band where the external wireless communication system exits.

20. The method of claim 17, further comprising:
down sampling a signal of the filtered frequency band to be used by the terminal,
wherein a sampling rate of the down sampling unit is determined based on the pass band of the band pass filter.
